(19) United States
(12) Patent Application Publication
(10) Pub. No.: US 2009/0263995 A1
(43) Pub. Date: Oct. 22, 2009

(54) CARD ADAPTER

(75) Inventors: Takeshi MURAYAMA, Miyagi-ken (JP); Toru WAGATSUMA, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/417,192

(22) Filed: Apr. 2, 2009

(30) Foreign Application Priority Data
Apr. 17, 2008 (JP) 2008-108012

(51) Int. Cl. H01R 13/62; H01R 31/06

(52) U.S. Cl. 439/152; 439/628

(57) ABSTRACT

A card adapter mounted on a card connector in a state where a card is held is provided. The card adapter includes an adapter body guided by a guide member which guides a separate card different from the card when being mounted to the card connector, and mounted on the card connector so as not to come into contact with contact terminals for the separate card; and a holding portion making the card held by the adapter body in a state where a rear end of the card is made to protrude from a rear end of the adapter body. The holding portion includes an ejection mechanism ejected by once pressing the card held by the adapter body toward the deep side.

### CROSS REFERENCE TO RELATED APPLICATION

The present application contains subject matter related to and claims priority to Japanese Patent Application JP2008-108012 filed in the Japanese Patent Office on Apr. 17, 2008, the entire contents of which are incorporated herein by reference.

### BACKGROUND

1. Technical Field

The present disclosure relates to a card adapter to be mounted on a card connector in a state where a card is held.

2. Related Art

A card connector in which a plurality of contact terminals are arranged at upper and lower stages such that they are shifted in the insertion and extraction direction of a card, one contact terminals are formed in a cantilevered shape, and the other contact terminals are formed in a pin shape is disclosed in Japanese Unexamined Patent Application Publication No. 6-44052. In the card connector disclosed in this Patent Document 1, a plurality of cards including a card which contacts the cantilevered contact terminals and a separate card which contacts the pin-shaped contact terminals can be selectively mounted.

In such a card connector disclosed in Japanese Unexamined Utility Model Registration Application Publication No. 6-44052, it is performed in the related art that a card adapter holding a card is mounted instead of mounting a card. That is, in a case where one card of a plurality of cards is set to be narrower than the other card, a card adapter having a width equal to the width of the other card and holding the aforementioned one narrower card is included, and it is performed in the related art that this card adapter and the aforementioned other card is mounted selectively. As the aforementioned card adapter, for example, there is one shown in Japanese Unexamined Patent Application Publication No. 6-318390. Additionally, as a card adapter including an ejection mechanism which ejects the held card, for example, there are those in Japanese Examined Utility Model Registration Application Publication No. 3089319 and Japanese Unexamined Patent Application Publication No. 2003-187904.

The length of each narrow card held by a related-art card adapter shown in the aforementioned Unexamined Patent Application Publication No. 6-318390, Japanese Examined Utility Model Registration Application Publication No. 3089319, and Japanese Unexamined Patent Application Publication No. 2003-187904 was also shorter compared with a broad card to be directly mounted on a card connector. However, it has recently been desired that a card which is set narrower compared with a broad card but is set longer than the broad card is held by a card adapter similarly to those in the related art and mounted on the card connector, and the transmission and reception of a signal to/from the long card is allowed. That is, in the related art, a card adapter which can hold a card which is set narrower compared with a broad card but is set longer than the broad card was not considered.

### SUMMARY

It is desirable to provide a card adaptor capable of holding a card which is narrower and longer compared with a card to be directly mounted on a card connector, and simply ejecting the held long card.

The card adapter according to an embodiment of the invention is a card adapter mounted on a card connector in a state where a card is held. The card adapter includes an adapter body guided by a guide member which guides a separate card different from the card when being mounted to the card connector, and mounted on the card connector so as not to come into contact with contact terminals for the separate card; and a holding portion making the card held by the adapter body in a state where a rear end of the card is made to protrude from a rear end of the adapter body. The holding portion includes an ejection mechanism ejected by once pressing the card held by the adapter body toward the deep side.

In the invention configured in this way, the holding portion can make the card held by the adapter body so that the rear end of the card does not protrude from the adapter body. Additionally, when the card held by the adapter body is ejected, the card can be simply ejected by the ejection mechanism only by the operation of pushing the rear end of the card protruding from the adapter body toward the deep side.

Additionally, in the card adapter according to the embodiment of the invention, preferably, the ejection mechanism includes a slider having an engaging portion which engages the card, and when the card is held by the adapter body, the holding portion holds the card so that the engaging portion of the slider is made to protrude forward from a front end of the adapter body and a front end of the card is made not to protrude from the front end of the adapter body.

In the invention configured in this way, when the adapter body is arranged such that the card is located in the mounting position of the card connector, the engaging portion of the slider can be located in a dead space of the card connector. When the card is ejected, the rear end of the card which protrudes from the rear end of the adapter body is pushed, so that the slider of the ejection mechanism can slide in its ejection direction, and the card can be simply ejected from the adapter body via the engaging portion of the slider. This makes it possible to easily pull the card out of the adapter body.

Additionally, in the card adapter according to the embodiment of the invention, preferably, the adapter body includes a housing portion which houses the card so as to be able to contact the contact terminals arranged above the contact terminals for the separate card provided in the card connector, and houses the card such that the bottom face of the card is made higher than the height position of the contact terminals for the separate card. In the invention configured in this way, when the adapter body is mounted on the card connector in a state where the card is housed and held in the housing portion of the adapter body, the card does not contact with the contact terminals for the separate card. This makes it possible to protect the card and the contact terminals for the separate card.

Additionally, in the card adapter according to the embodiment of the invention, preferably, the adapter body has a recess which houses the contact terminals for the separate card provided in the card connector. In the invention configured in this way, the adapter body can be mounted on the card connector without interfering with the contact terminals for the separate card provided in the card connector.

Additionally, in the card adapter according to the embodiment of the invention, preferably, the holding portion includes an engagement piece with which engages a recess formed at a side portion of the card. In the invention configured in this way, the engagement between the recess of the card and the engagement piece enables the card to be held by the adapter body so that chattering does not occur within a horizontal plane,

Additionally, in the card adapter according to the embodiment of the invention, preferably, the holding portion includes regulating pieces which regulate the upward movement of the upper face of the card. In the invention configured in this way, the regulating pieces enable the card to be held by the adapter body so that chattering does not occur in a vertical direction,

Additionally, in the card adapter according to the embodiment of the invention, preferably, the adapter body has notches which avoid interference with the ejection mechanism for the separate card when the adapter body is mounted on the card connector. In the invention configured in this way, the notches enables the adapter body to be held by the card connector without exerting any influence on the operation of the ejection mechanism of the separate card provided in the card connector, and only the card can be ejected from the card connector by operating the ejection mechanism of the holding portion.

Additionally, in the card adapter according to the embodiment of the invention, preferably, the engagement piece is provided in the slider. In the invention configured in this way, the recess of the card and the engagement piece can be engaged with each other so as to follow movement of the card inserted into the adapter body, and the card can be stably held by the adapter body.

The card adapter according to the embodiment of the invention includes a holding portion making the card held by the adapter body in a state where a rear end of the card is made to protrude from a rear end of the adapter body, and the holding portion includes an ejection mechanism ejected by once pressing the card held by the adapter body toward the deep side. Thus, a card which is narrower and longer compared with a card to be directly mounted on a card connector can be held by the holding portion, and the held long card can be simply ejected by the ejection mechanism. Accordingly, it is possible to cope with a related-art request for holding the long card compared with a card to be directly mounted on the card connector, the ejection of the long card from the adapter body becomes easy, and excellent convenience can be secured.

### BRIEF DESCRIPTION OF THE DRAWINGS

FIG. 1 is a plan view showing a separate card to be directly mounted on a card connector.

FIG. 2 is a plan view showing a card held by a card adapter according to one embodiment of the invention.

FIG. 3 is a plan view showing a card connector to be mounted with the card adapter according to this embodiment.

FIG. 4 is a plan view showing essential portions of the card connector shown in FIG. 3.

FIG. 5 is a plan view showing the card adapter according to this embodiment.

FIG. 6 is a plan view showing a portion in an exploded manner from a state shown in FIG. 5.

FIG. 7 is a perspective view showing an adapter body provided in the card adapter according to this embodiment.

FIG. 8 is a plan view showing a state where the card shown in FIG. 2 is held by the card adapter according to this embodiment.

FIG. 9 is a plan view showing a state where a separate card shown in FIG. 1 is mounted on the card connector.

FIG. 10 is a plan view showing a state where the card adapter according to this embodiment holding a card is mounted on the card connector, and showing a state where the card is locked in a given position.

FIG. 11 is a plan view showing a state where the card has been over-stroked when the card is ejected from the card adapter according to this embodiment.

FIG. 12 is a plan view showing a state where the card has been ejected from the card adapter, i.e., the card connector, according to this embodiment.

### DESCRIPTION OF EXEMPLARY EMBODIMENTS

Hereinafter, best modes for carrying out a card adapter according to an embodiment of the invention will be described with reference to the accompanying drawings.

### [Card Used for Card Connector]

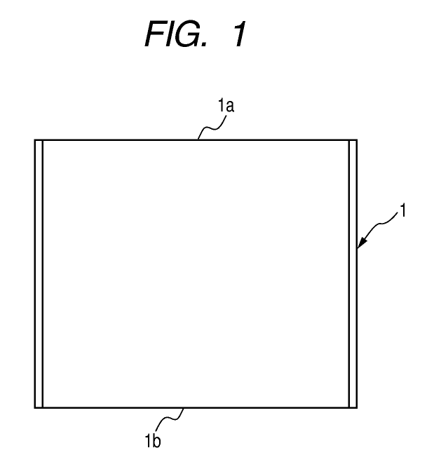

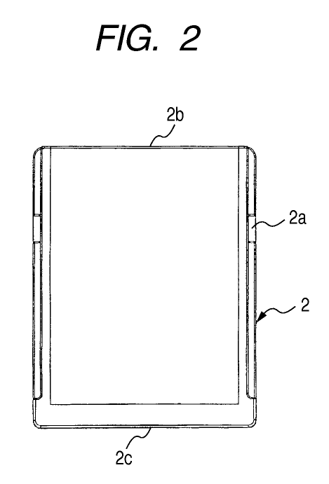

FIG. 1 is a plan view showing a separate card to be directly mounted to the card connector, and FIG. 2 is a plan view showing a card held by the card adapter according to one embodiment of the invention.

A separate card 1 shown in FIG. 1 is a card to be directly mounted on a card connector 3 which will be described later, and is mounted on the card connector 3, for example, by gripping a rear end 1b and inserting the card into the card connector 3 from a front end 1a. As the separate card 1 is mounted on the card connector 3 in this way, the transmission and reception of a signal to/from the separate card 1 become possible.

A card 2 shown in FIG. 2 is held by a card adapter A according to this embodiment which will be described later. As the card connector 3 is mounted on the card adapter A, the transmission and reception of a signal to/from the card 2 becomes possible. The card 2 is formed so as to be thinner, narrower, and longer than the aforementioned the separate card 1. The card has a recess 2a at one side portion thereof. Additionally, the card 2 is held by the card adapter A, for example, by gripping the rear end 2c and inserting the card into the card adapter A from a front end 2b.

[Configuration of Card Connector to be Mounted with Card Adapter According to this Embodiment]

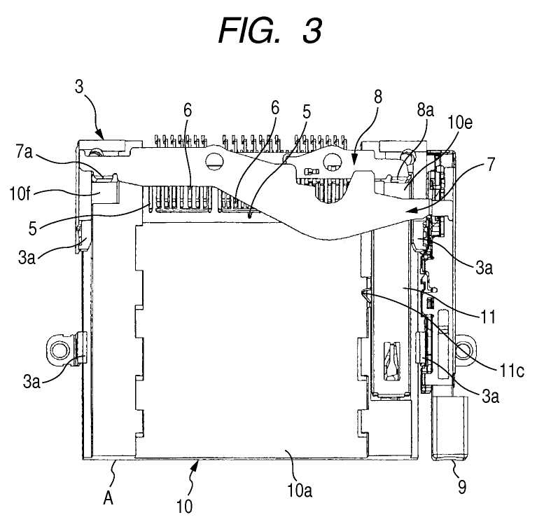

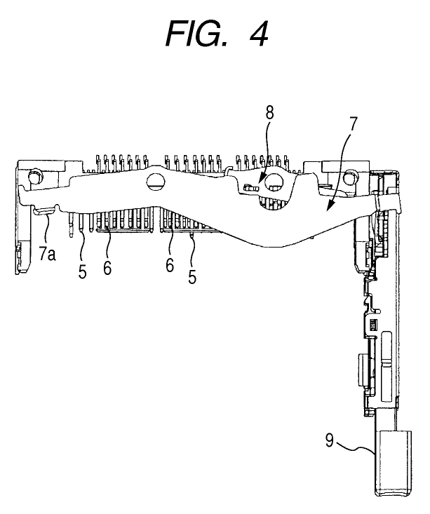

FIG. 3 is a plan view showing a card connector to be mounted with the card adapter according to this embodiment, and FIG. 4 is a plan view showing essential portions of the card connector shown in FIG. 3.

As shown in FIGS. 3 and 4, the card connector 3 to be mounted with the card adapter A according to this embodiment has a plurality of contact terminals 5, which contacts a contact portion of the separate card 1 shown in FIG. 1 and is formed in a pin shape, for example, at a lower stage of a deep-side position, and has a plurality of contact terminals 6, which contact the contact portion of the card 2 shown in FIG. 2 held by the card adapter A and is formed in a cantilevered shape, at an upper stage of the deep-side position, i.e., in positions above the contact terminals 5. Additionally, the card connector 3 includes a plurality of guide members 3a which guides both side portions of the separate card 1, and both side portions of the card adapter A.

Moreover, this card connector includes an ejection mechanism which ejects the separate card 1 to be mounted on the card connector 3. This ejection mechanism has a rotatable first ejecting lever 7 having an engaging portion 7a which engages a left portion of the front end 1a of the separate card 1 mounted on the card connector 3, a second ejecting lever 8 which rotates in an interlocking manner with the rotation of the first ejecting lever 7 and has an engaging portion 8a which engages a right portion of the front end 1a of the separate card 1, and a push lever 9 which engages the first ejecting lever 7 and rotates the first ejecting lever 7.

The state shown in FIG. 4 shows the positional relationship among the push lever 9, the first ejecting lever 7, and the second ejecting lever 8 when the separate card 1 is mounted on the card connector 3. At the time of ejection of the separate card 1, the operation of pulling the push lever 9 once toward a user and then pushing the push lever 9 is performed. By the push operation of the push lever 9, the first ejecting lever 7 rotates counterclockwise in FIG. 4, and the second ejecting lever 8 rotates clockwise in conjunction with such rotation, the engaging portions 7a and 8a of the first and second ejecting lever 7 and 8 push the front end 1a of the separate card 1 mounted on the card connector 3. This ejects the separate card 1.

The card connector 3 configured in this way is arranged on a substrate (not shown) via, for example, fasteners, such as screws. The contact terminals 5 and 6 are connected wiring lines on the substrate, for example, by soldering.

[Configuration of Card Adapter according to this Embodiment]

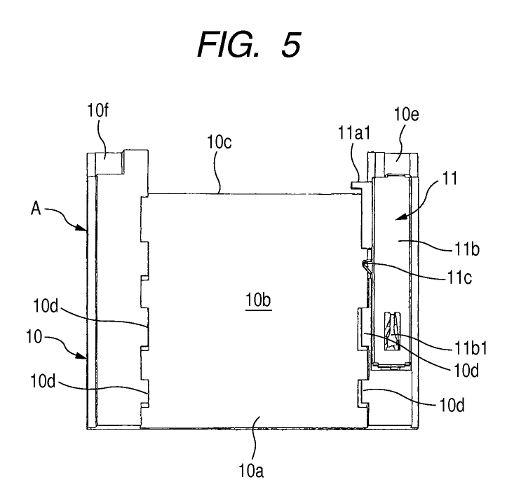

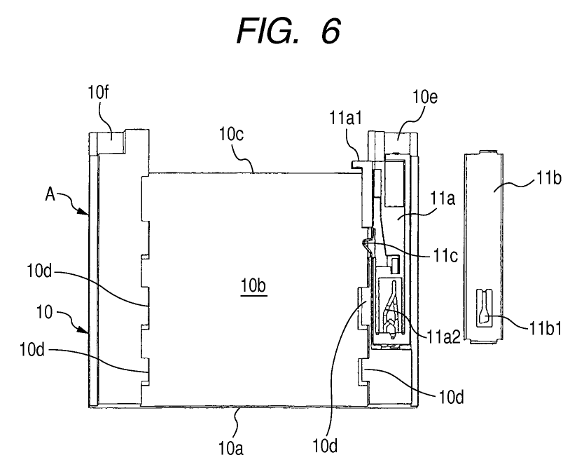

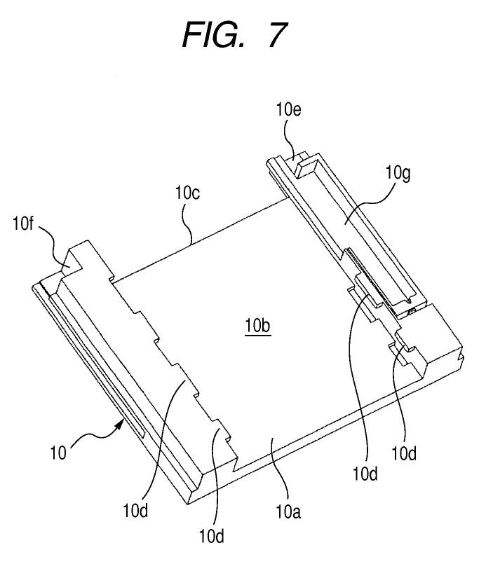

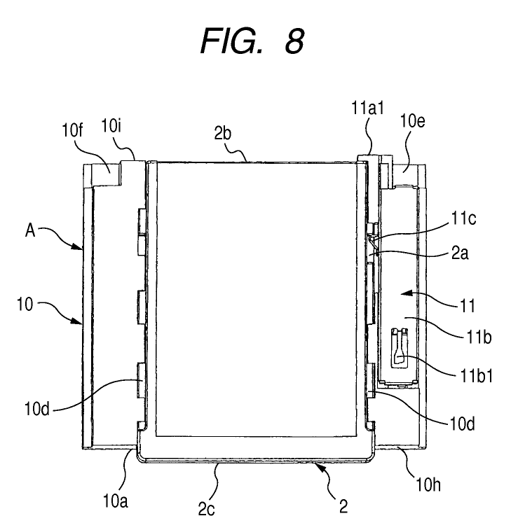

FIG. 5 is a plan view showing the card adapter according to this embodiment, FIG. 6 is a plan view showing a portion in an exploded manner from a state shown in FIG. 5, FIG. 7 is a perspective view showing an adapter body provided in the card adapter according to this embodiment, and FIG. 8 is a plan view showing a state where the card shown in FIG. 2 is held by the card adapter according to this embodiment.

The card adapter A according to this embodiment, as shown in FIG. 7 and the like, is guided by the aforementioned guide members 3a which guide the separate card 1 when being mounted to the card connector 3, and has an adapter body 10 to be mounted on the card connector 3 so as not to contact the contact terminals 5 for the separate card 1. The adapter body 10 has, for example, the same width and length as the separate card 1. Additionally, as shown in FIG. 8, the adapter body includes a holding portion which makes the card 2 held by the adapter body 10 in a state where the rear end 2c of the card 2 is made to protrude from a rear end 10h of the adapter body 10. This holding portion includes a push-push type ejection mechanism 11 shown in FIGS. 5 and 6 which presses the card 2 held by the adapter body 10 once toward the deep side to eject the card.

The ejection mechanism 11 includes a slider 11a having an engaging portion 11a1 that the card 2 engages. As shown in FIG. 8, when the card 2 is held by the adapter body 10, the aforementioned holding portion holds the card 2 so that the engaging portion 11a1 of the slider 11a is made to protrude forward from a front end 10i of the adapter body 10 and the front end 2b of the card 2 is made not to protrude from the front end 10i of the adapter body 10.

The slider 11a is slidably arranged in a housing portion 10g of the adapter body 10 shown in FIG. 7. For example, the slider 11a is provided with a heart cam 11a2, and an resilient piece 11b1 formed in a cover member 11b which covers the slider 11a and is fixed to the adapter body 10 is provided with a pin (not shown) which engages the heart cam 11a2 and is relatively slidable between the resilient piece and the heart cam 11a2. Additionally, the slider 11a is biased in the direction of an insertion slot 10a of the adapter body 10, i.e., in an ejection direction of the card 2, by a resilient member which is not shown.

The aforementioned adapter body 10 includes a housing portion 10b which houses the card 2 so as to be able to contact the contact terminals 6 arranged above the contact terminals 5 for the separate card 1 provided in the card connector 3, and houses the card 2 such that the bottom face of the card 2 is made higher than the height position of the contact terminals 5 for the separate card 1.

Additionally, the adapter body 10 has a recess 10c which houses the contact terminals 5 for the separate card 1 provided in the card connector 3, as shown in FIG. 5 and the like. Additionally, both corners of the front end 10i the adapter body 10 are respectively provided with notches 10e and 10f which avoid interference with the ejection mechanism of the separate card 1 when the adapter body 10 is mounted on the card connector 3, that is, interference with the engaging portion 7a of the first ejecting lever 7 and the engaging portion 8a of the second ejecting lever 8 which constitutes the ejection mechanism.

Additionally, the aforementioned holding portion includes an engagement piece 11c with resilience which engages the recess 2a formed at a side portion of the card 2, and the engagement piece 11c is provided in the slider 11a by insert molding, for example, as shown in FIG. 6.

Moreover, the aforementioned holding portion includes regulating pieces 10d which regulate the upward movement of the upper face of the card 2, and the regulating pieces 10d are formed in the adapter body 10 as shown in FIG. 7 and the like.

As shown in FIG. 8, the holding portion which makes the card 2 held by the adapter body 10 in a state where the rear end 2c of the card 2 is made to protrude from the rear end 10h of the adapter body 10, as mentioned above, includes the ejection mechanism 11 provided in the adapter body 10, the housing portion 10b of the adapter body 10, the engagement piece 11c provided in the slider 11a, and the regulating pieces 10d provided in the adapter body 10.

### [Mounting of a Separate Card to the Card Connector]

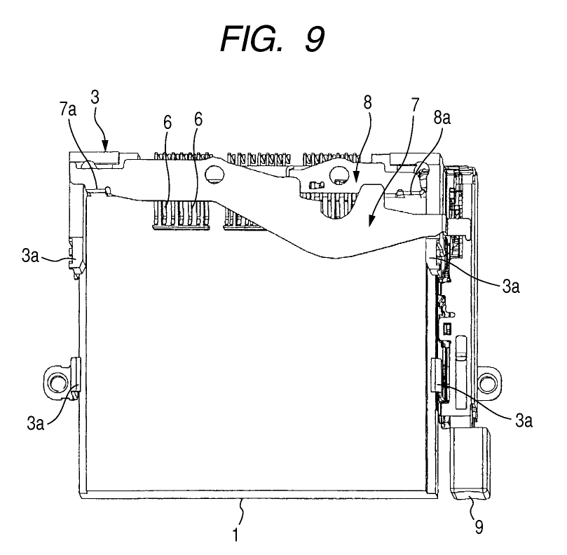

FIG. 9 is a plan view showing a state where a separate card shown in FIG. 1 is mounted on the card connector.

As shown in FIG. 9, when the separate card 1 is inserted into the card connector 3 in mounting the separate card 1 on the card connector 3, the separate card 1 is guided by the guide members 3a of the card connector 3, and is positioned and locked in a predetermined mounting position. In a state where the separate card 1 is mounted on the card connector 3, the contact portion of the separate card 1 contacts the contact terminals 5, and the transmission and reception of a signal to/from the separate card 1 become possible. Additionally, in a state where the separate card 1 is mounted in this way, the engaging portion 7a of the first ejecting lever 7 engages the left portion of the front end 1a of the separate card 1, and the engaging portion 8a of the second ejecting lever 8 engages the right portion of the front end 1a of the separate card 1.

When the separate card 1 is ejected from the card connector 3, as mentioned above, the operation of pulling the push lever 9 once toward a user and then pushing the push lever 9 is performed. Thereby, by the engaging portion 7a of the first ejecting lever 7 and the engaging portion 8a of the second ejecting lever 8 which engage the push lever 9, the front end 1a of the separate card 1 is pushed, and the separate card 1 is ejected. Accordingly, the separate card 1 can be pulled out of the card connector 3 with the rear end 1b of the ejected separate card 1 being gripped.

[Mounting Card Adapter According to this Embodiment Holding Card to Card Connector]

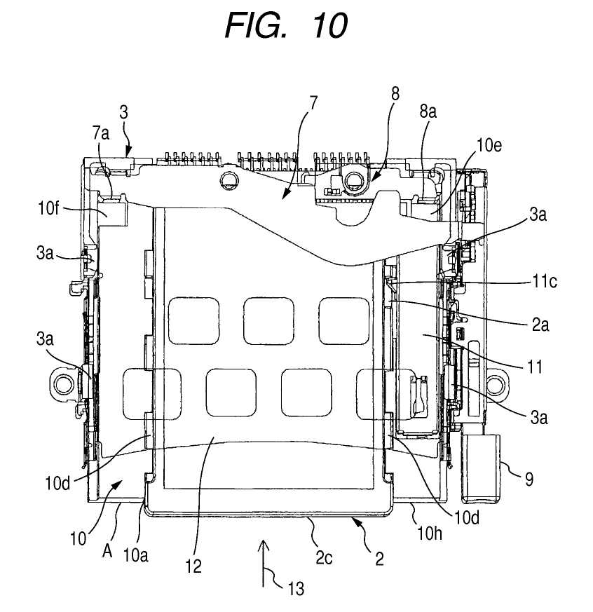

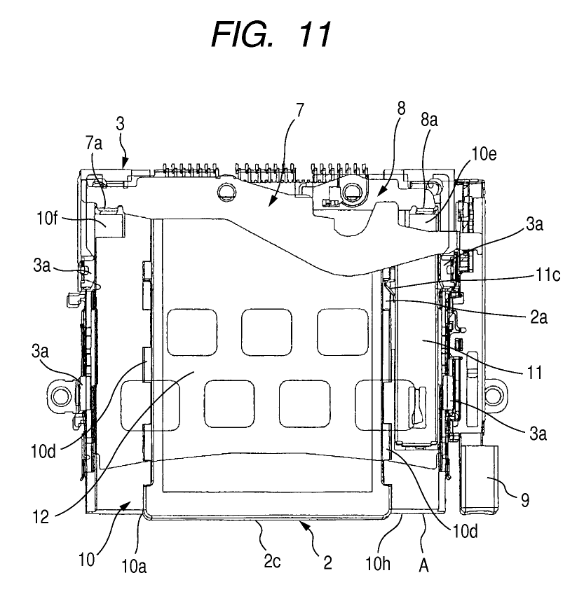

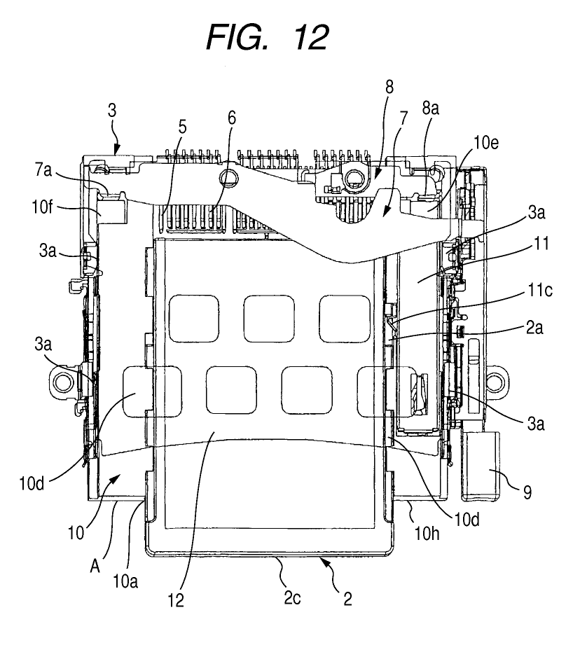

FIG. 10 is a plan view showing a state where the card adapter according to this embodiment holding a card is mounted on the card connector, and showing a state where the card is locked in a given position, FIG. 11 is a plan view showing a state where the card has been over-stroked when the card is ejected from the card adapter according to this embodiment, and FIG. 12 is a plan view showing a state where the card has been ejected from the card adapter, i.e., the card connector, according to this embodiment.

When the card 2 is held by the card adapter A, the card 2 is inserted toward the housing portion 10b from the insertion slot 10a of the adapter body 10, and when the rear end 2c of the card 2 is pushed, the front end 2b of the card 2 engages the engaging portion 11a1 of the slider 11a, and the slider 11a slides against the resilient force of the resilient member (not shown). Thereby, a pin (not shown) of the resilient piece 11b1 relatively slides on the heart cam 11a2 of the slider 11a. Additionally, while the upward movement of the upper face of a card 2 is regulated by the regulating pieces 10d of the adapter body 10, the engagement piece 11c provided in the slider 11a engages the recess 2a provided at a side portion of the card 2. When the card 2 is further pushed in from this state, the pin (not shown) of the resilient piece 11b1 engages a locking portion of the heart cam 11a, and the card 2 is housed in the housing portion 10b, is locked in a predetermined mounting position, and is brought into the aforementioned state shown in FIG. 8. In this state, as mentioned above, the rear end 2c of the card 2 is maintained in a state where it protrudes from the rear end 10h of the adapter body 10, the front end 2b of a card 2 is maintained so as not to protrude from the front end 10i of the adapter body 10, and the engaging portion 11a1 of the slider 11a is maintained in a state where it protrudes slightly from the front end 10i of the adapter body 10.

When the card adapter A is mounted to the card connector 3, as shown in FIG. 8, the card adapter A holding the card 2 is inserted into the card connector 3. At this time, similarly to the insertion of the separate card 1, the card adapter A is guided by the guide members 3a of the card connector 3, and as shown in FIG. 10, is positioned and locked in a predetermined mounting position. In this state, the contact portion of the card 2 contacts the contact terminals 6, and the transmission and reception of a signal to/from the card 2 become possible. In addition, although illustration is omitted in FIGS. 3 and 9 mentioned above, as shown in FIG. 10, the card connector 3 is provided with a cover member 12 which covers the upper face of the card 2 held by the card adapter A.

After the card adapter A according to this embodiment instead of the aforementioned separate card 1 is mounted on the card connector 3, for example, the card adaptor is locked so that it cannot be pulled out of the card connector 3, and it is considered that the card adaptor becomes a structure which is integral with the card connector 3. Therefore, as mentioned above, the notches 10e and 10f which avoid interference with the engaging portion 7a of the first ejecting lever 7 and the engaging portion 8a of the second ejecting lever 8 are provided near both the corners of the front end 10i of the adapter body 10. Accordingly, as shown in FIG. 10, in a state where the card adapter A is inserted into the card connector 3, and is positioned and locked in a predetermined mounting position, even if the first ejecting lever 7 and the second ejecting lever 8 are rotated by push-pull operation of the push lever 9, the adapter body 10 of the card adapter A is held by the card connector 3, without being ejected.

When the card 2 is ejected, as indicated by an arrow 13 of FIG. 10, the rear end 2c of the card 2 is pushed, and thereby, as shown in FIG. 11, the card 2 is over-stroked, and the slider 11a slides slightly further forward via the engaging portion 11a1 which engages the card 2. Along with this, the heart cam 11a2 of the slider 11a moves, and the pin (not shown) provided in the resilient piece 11b1 is separated from the locking portion of the heart cam 11a2, whereby the lock of the card 2 is released. Accordingly, when a pressing force which has been applied to the card 2 is released, the slider 11a slides in the direction of the insertion slot 10a of the adapter body 10 by the resilient force of the resilient member (not shown) which biases the slider 11a, and is pushed to the engaging portion 11a1 of the slider 11a, whereby only the card 2 is ejected as shown in FIG. 12. By gripping the rear end 2c of the ejected card 2, the card 2 can be easily pulled out of the adapter body 10, i.e., the card connector 3.

[Effects of Card Adapter according to this Embodiment]

In the card adapter A according to this embodiment configured in this way, a holding portion including the ejection mechanism 11, the housing portion 10b of and the adapter body 10, the engagement piece 11c, and the regulating pieces 10d is able to make the card 2 held by the adapter body 10 such that the rear end 2c of the card protrudes from the adapter body 10. Additionally, when the card 2 held by the adapter body 10 is ejected, the card 2 can be simply ejected by the ejection mechanism 11 only by the operation of pushing the rear end 2c of the card 2 protruding from the adapter body 10. Accordingly, it is possible to cope with a request for holding a long card 2 shown in FIG. 2 compared with the separate card 1 shown in FIG. 1 to be directly mounted on the card connector 3, the ejection of the long card 2 from the adapter body 10 becomes easy, and excellent convenience can be secured.

Additionally, when the adapter body 10 has been arranged such that the card 2 is located in the mounting position of the card connector 3, the engaging portion 11a1 of the slider 11a can be located in a dead space of the card connector 3, the dead space of the card connector 3 can be effectively utilized, and the sliding operation of the slider 11a can be smoothly performed.

Additionally, the adapter body 10 includes a housing portion 10b which houses the card 2 so as to be able to contact the contact terminals 6 arranged above the contact terminals 5 for the separate card 1 provided in the card connector 3, and houses the card 2 such that the bottom face of the card 2 is made higher than the height position of the contact terminals 5 for the separate card 1. Therefore, when the adapter body 10 is mounted on the card connector 3 in a state where the card 2 is housed and held in the housing portion 10b of the adapter body 10, the card 2 does not contact with the contact terminals 5 for the separate card 1. This makes it possible to protect the card 2 and the contact terminals 5 for the separate card 1.

Additionally, since the adapter body 10 has the recess 10c which houses the contact terminals 5 for the separate card 1 provided in the card connector 3, the adapter body 10 can be mounted on the card connector 3 without interfering with the contact terminals 5 for the separate card 1 provided in the card connector 3.

Additionally, since the engagement piece 11c which engages the recess 2a formed at the side portion of the card 2 is provided, the card 2 can be held by the adapter body 10 so that chattering does not occur within a horizontal plane. Additionally, since the aforementioned engagement piece 11c is provided in the slider 11a, the recess 2a of the card 2 and the engagement piece 11c can be engaged with each other so as to follow movement of the card 2 inserted into the adapter body 10, and the card 2 can be stably held by the adapter body 10.

Additionally, since the regulating pieces 10d which regulate the upward movement of the upper face of the card 2 are provided, the card 2 can be held by the adapter body 10 so that chattering does not occur in a vertical direction. Additionally, since the regulating pieces 10d are provided in the adapter body 10, the regulating pieces 10d can be formed simultaneously with manufacture of the adapter body 10, and the regulating pieces 10d can be easily provided.

Additionally, since the adapter body 10 has the notches 10e and 10f which avoid interference with the ejection mechanism of the separate card 1, i.e., the first ejecting lever 7 and the second ejecting lever 8 when being mounted to the card connector 3, the notches 10e and 10f enables the adapter body 10 to be held by the card connector 3 without exerting any influence on the operation of the ejection mechanism of the separate card 1 provided in the card connector 3, and only the card 2 can be ejected from the card connector 3 by slidingly operating the ejection mechanism 11, i.e., the holding portion 11a.

In addition, in a case where it is desired that ejection from the card connector 3 of the card adapter A is allowed unlike the aforementioned case, the adapter body 10 may not be provided with the aforementioned notches 10e and 10f. If this configuration is adopted, the first ejecting lever 7 and the second ejecting lever 8 are rotated by the aforementioned push operation of the push lever 9 shown in FIG. 4, and the front end 10i of the card adapter A mounted on the card connector 3 is pushed by the engaging portions 7a and 8a of the first and second ejecting levers 7 and 8, so that the card adapter A can be ejected from the card connector 3, for example, in a state where the card 2 is held thereby.

It should be understood by those skilled in the art that various modifications, combinations, sub-combinations and alternations may occur depending on design requirements and other factors insofar as they are within the scope of the appended claims of the equivalents thereof.

What is claimed is:

1. A card adapter mounted on a card connector in a state where a card is held, the card adapter comprising:
an adapter body guided by a guide member which guides a separate card different from the card when being mounted to the card connector, and mounted on the card connector so as not to come into contact with contact terminals for the separate card; and
a holding portion making the card held by the adapter body in a state where a rear end of the card is made to protrude from a rear end of the adapter body,
wherein the holding portion includes an ejection mechanism ejected by once pressing the card held by the adapter body toward the deep side.

2. The card adapter according to claim 1,
wherein the ejection mechanism includes a slider having an engaging portion which engages the card, and when the card is held by the adapter body, the holding portion holds the card so that the engaging portion of the slider is made to protrude forward from a front end of the adapter body and a front end of the card is made not to protrude from the front end of the adapter body.

3. The card adapter according to claim 1,
wherein the adapter body includes a housing portion which houses the card so as to be able to contact the contact terminals arranged above the contact terminals for the separate card provided in the card connector, and houses the card such that the bottom face of the card is made higher than the height position of the contact terminals for the separate card.

4. The card adapter according to claim 1,
wherein the adapter body has a recess which houses the contact terminals for the separate card provided in the card connector.

5. The card adapter according to claim 1,
wherein the holding portion includes an engagement piece with which engages a recess formed at a side portion of the card.

6. The card adapter according to claim 1,
wherein the holding portion includes regulating pieces which regulate the upward movement of the upper face of the card.

7. The card adapter according to claim 1,
wherein the adapter body has notches which avoid interference with the ejection mechanism for the separate card when the adapter body is mounted on the card connector.

8. The card adapter according to claim 5,
wherein the engagement piece is provided in the slider.
